(19) United States
(12) Patent Application Publication
(10) Pub. No.: US 2024/0311829 A1
(43) Pub. Date: Sep. 19, 2024

(54) SYSTEM AND METHOD FOR IMPLEMENTING FLEXBLE VIRTUAL CARD NUMBER TRANSACTIONS BASED ON MAPPING TO AN OFFLINE ATTRIBUTE

(71) Applicant: Capital One Services, LLC, McLean, VA (US)

(72) Inventors: Michael WOLF, Ellicott City, MD (US); Salik SHAH, Washington, DC (US); Paul Young MORETON, Tuscaloosa, AL (US)

(21) Appl. No.: 18/121,253

(22) Filed: Mar. 14, 2023

(51) Int. Cl. G06Q 20/40; G06Q 20/34

(52) U.S. Cl. CPC G06Q 20/4012; G06Q 20/351

(57) ABSTRACT

The disclosed system and method is directed to enhancing feasibility of virtual card numbers (VCNs), as secure transaction instruments in online electronic transaction, by incorporating an offline attribute value, which may correspond to an element of the users physical card such as the CVV code, into the validation parameters specified for a VCN. This functionality may be implemented, on the validation end, by modifying a VCN data object to include a reference to the corresponding data element. The proposed system and method provides a more flexible and feasible implementation for conducting VCN transactions without compromising authentication security across network connections.

### FIELD OF THE DISCLOSURE

The present disclosure relates to systems and methods for improving feasibility of virtual card numbers in electronic transactions, and more specifically to systems and methods for providing a flexible implementation of online virtual card number transactions.

### BACKGROUND

In electronic commerce, often times on-line credit card transactions require additional authentication information tied to either a user and/or a payment card (e.g., credit/debit card) associated with an electronic payment transaction. This authentication information generally corresponds to a three digit card verification value (CVV) code which is often utilized for completing online transactions as a safeguard against misuse by unauthorized entities. In this way, even if a credit card number is electronically compromised, the stolen number cannot be used towards conducting a transaction without the CVV. However, a CVV, unlike other details of a credit/debit card, may not be stored while swiping or while punching in the card information for conducting an online transaction.

A problem may arise when an online electronic transaction is conducted with a virtual card number (VCN) that is bound to a specific merchant at embossing (e.g., binding a specific merchant identifier to the sequence of characters comprising the VCN.) A VCN may be associated with additional virtual data such as a virtual CVV code, which for purposes of security, may not be saved or retained by a merchant system. Therefore, similar to a physical credit/debit card transaction requiring additional data corresponding to a physical CVV code, a user may be required to provide a specific virtual CVV when conducting an online VCN transaction. The virtual CVV for a specific VCN, however, may not readily accessible to the user initiating the VCN transaction thus limiting functionality of merchant-specific VCNs as secure transaction instruments. These and other deficiencies exist.

SUMMARY OF THE DISCLOSURE

One aspect of the present disclosure is directed to a process for improving feasibility of online VCN transactions without compromising operational security. One exemplary implementation may involve modifying a back-end VCN validation process flow by introducing an offline attribute value, that may be readily available to a user, as an additional and/or alternate validation parameter. In some cases, the aforementioned offline attribute may correspond to a CVV code associated with a physical debit/credit card tied to a user's primary financial account.

Accordingly some embodiments are directed to a method for improving security and feasibility of VCN transaction, the method comprising: mapping, via a back-end process, one or more VCNs to a first security code associated with a physical card linked to a user's account, wherein each of the one or more VCNs are associated with a second security code corresponding to a unique VCN-specific virtual security code. The VCN identifier and a corresponding virtual CVV code along with other virtual information associated with the VCN may be stored as specific parameter values within a distinct data object. There may be other data objects storing attribute values associated with the user's primary account and/or physical debit/credit card. According to an embodiment of the present disclosure, one or more VCN data objects, associated with distinct merchants, may be mapped to a user account attribute that maybe known and/or readily accessible by a user. The aforementioned attribute value may then be provided by a user when initiating a VCN transaction in addition and/or as an alternative to a virtual attribute that may be required along with the VCN for validating the transaction. One example of such an attribute value may correspond to the printed card verification value (CVV) on a corresponding physical debit/credit card associated with the user.

Accordingly, the method may further comprise receiving, by a back-end validation process, an electronic verification code transmitted in conjunction with an incoming VCN transaction, wherein the electronic verification code and the incoming VCN transaction string are provided via separate network sessions. Upon receiving the VCN transaction string and a corresponding electronic verification code (e.g., CVV), a back-end validation process may be configured to determine a match between the electronic verification code and either a corresponding first CVV code associated with the physical card, or a second virtual CVV code associated with the incoming VCN. As such the back-end process may match the received verification code with two distinct stored values corresponding to the virtual CVV associated with the VCN and the physical CVV associated, for example, with a physical debit/credit card, with either match producing a validation response.

According, the method may further comprise validating, by the back-end validation process, the incoming VCN transaction request based on a match between a user-provided security code, corresponding to the physical CVV.

In some embodiments of the present disclosure, a back-end validation process may be configured to generate the virtual and/or the physical CVV, in response to a VCN transaction validation request, instead of statically storing the corresponding values to facilitate the validation process. The virtual and the physical CVV may be generated, by the back-end validation process using distinct algorithms. In some instances a common algorithm may be used to generated the virtual and physical CVV based on the virtual card and the physical card information, respectively.

As discussed above, a feature of a CVV code is that it may not be stored by a transacting system (e.g. a merchant system). In accordance to some embodiments of the present disclosure a virtual and/or a physical CVV associated with a VCN transaction may be (temporarily) cached by a merchant system when the VCN is initially provided to the merchant system in service of a user transaction with the merchant.

Some embodiments of the present disclosure are directed to a system for enhancing useability and security associated with VCN-based transactions, the system comprising: a computer hardware arrangement comprising a computing device storing merchant-specific VCN identifiers and is communicatively coupled with a corresponding application running on a VCN validation server, the hardware arrangement being configured to map, via a back-end process on the validation server, one or more virtual card numbers (VCNs), to a first security code associated with a physical card linked to a user's account, wherein each of the one or more VCNs is associated with a second security code corresponding to a unique VCN-specific virtual security code. The VCN identifier and a corresponding virtual CVV code along with other virtual information associated with the VCN may be stored as distinct data object with specific corresponding parameter values. There may be other data objects storing, for example, attributes associated with the user's primary account and/or physical debit/credit card. According to an embodiment of the present disclosure, one or more VCN data object, associated with distinct merchants, may be mapped to a user account attribute that maybe known by and/or readily accessible by a user. The aforementioned attribute value may then be provided by a user when initiating a VCN transaction in addition and/or as an alternative to a virtual attribute that may be required along with the VCN for validating the transaction. One example of such an attribute value may correspond to the printed CVV on a corresponding physical debit/credit card associated with the user.

Accordingly, the system may be further configured to transmit, to a back-end validation process, an electronic verification code associated with a VCN transaction string, and the VCN transaction string, via distinct network sessions. Upon receiving the VCN transaction string and a corresponding electronic verification code (e.g., CVV), a back-end validation process may be configured to determine a match between electronic verification code and one of the first CVV code associated with the physical card, and the second (virtual) CVV code associated with the incoming VCN. As such the back-end process may match the received verification code with two distinct stored values corresponding to the virtual CVV associated with the VCN and the physical CVV associated, for example, with a physical debit/credit card, with either match producing a validation response.

According, the system may be configured to validate an incoming VCN transaction request based on a user-provided security code, corresponding to the physical CVV.

In some embodiments of the present disclosure, a back-end validation process may be configured to generate the virtual and/or the physical CVV, in response to a VCN transaction validation request, instead of statically storing the corresponding values to facilitate the validation process. The virtual and the physical CVV may be generated, by the back-end validation process using distinct algorithms. In some instances a common algorithm may be used to generated the virtual and physical CVV based on the virtual card information and the physical card, respectively. In accordance to some embodiments of the present disclosure a virtual and/or a physical CVV associated with a VCN transaction may be (temporarily) cached by a merchant server when the VCN is initially provided to the merchant server in service of a user transaction with the merchant.

Some embodiments of the present disclosure are directed to a non-transitory computer-readable medium comprising instructions for execution by a computer hardware arrangement, wherein upon execution of the instructions the computer hardware arrangement is configured to perform procedure comprising mapping, via a back-end process, one or more VCNs, to a first security code associated with a physical card linked to a user's account, wherein each of the one or more VCNs is associated with a second security code corresponding to a unique VCN-specific virtual security code. The VCN identifier and a corresponding virtual CVV code along with other virtual information associated with the VCN may be stored as distinct data object with specific corresponding parameter values. There may be other data objects storing, for example, attributes associated with the user's primary account and/or physical debit/credit card. According to an embodiment of the present disclosure, one or more VCN data object, associated with distinct merchants, may be mapped to a user account attribute that maybe known by and/or readily accessible by a user. The aforementioned attribute value may then be provided by a user when initiating a VCN transaction in addition and/or as an alternative to a virtual attribute that may be required along with the VCN for validating the transaction. One example of such an attribute value may correspond to the printed CVV on a corresponding physical debit/credit card associated with the user.

Accordingly, the non-transitory computer-readable medium may comprise further instructions for transmitting, to a back-end validation process, an electronic verification code associated with a VCN transaction string, and the VCN transaction string, via distinct network sessions. Upon receiving the VCN transaction string and a corresponding electronic verification code (e.g., a CVV), a back-end validation process may be configured to determine a match between electronic verification code and one of the first CVV code associated with the physical card, and the second (virtual) CVV code associated with the incoming VCN. As such the back-end process may match the received verification code with two distinct stored values corresponding to the virtual CVV associated with the VCN and the physical CVV associated, for example, with a physical debit/credit card, with either match producing a validation response.

According, the non-transitory computer-readable medium may comprise instructions for validating, by the back-end validation process, the incoming VCN transaction request based on a match between a user-provided security code corresponding to the physical CVV.

In some embodiments of the present disclosure, the non-transitory computer-readable medium may comprise instructions for generate the virtual and/or the physical CVV, in response to a VCN transaction validation request, instead of statically storing the corresponding values to facilitate the validation process. The virtual and the physical CVV may be generated using distinct algorithms. In some instances a common algorithm may be used to generated the virtual and physical CVV based on the virtual card information and the physical card, respectively.

In accordance to some embodiments of the present disclosure, the non-transitory computer-readable medium may comprise instructions for (temporarily) caching (e.g., by a transacting server) a virtual and/or a physical CVV associated with a VCN transaction, when the VCN is initially provided to the transacting server in service of a user transaction with, for example, a merchant (until a matching CVV is provided by the user and validated by the authentication/validation server).

### BRIEF DESCRIPTION OF THE DRAWINGS

Various embodiments of the present disclosure, together with further objects and advantages, may best be understood by reference to the following description taken in conjunction with the accompanying drawings.

FIG. 1 illustrates a general overview of VCN transaction processing highlighting a deficiency associated with processing of online VCN transactions.

FIG. 2A illustrates an exemplary implementation for storing VCN data objects, comprising validation parameters, on a back-end validation server for validating incoming VCN transactions, in accordance to some embodiments of the present disclosure.

FIG. 2B illustrates an exemplary implementation for mapping VCN data objects stored on a back-end validation server to an external data attribute as a back-up validation parameter for incoming VCN transactions, in accordance to some embodiments of the present disclosure.

FIG. 3 illustrates an exemplary process flow diagram for incorporating an external attribute into the processing of VCN transactions using two distinct transmission messages, in accordance to some embodiments of the present disclosure.

FIG. 4 illustrates an exemplary memory configuration and storage arrangement of VCN data objects comprising a mapping to an external parameter value, in accordance to some embodiments of the present disclosure.

FIG. 5 illustrates an exemplary flow chart of a back-end VCN validation process with modified mapping, in accordance to some embodiments of the present disclosure.

FIG. 6 is an illustration of an exemplary embodiments involving in-person initiated VCN transactions with enhanced security, in accordance to some embodiments of the present disclosure.

FIG. 7 is an illustration of an exemplary block diagram of an exemplary system, in accordance to some embodiments of the present disclosure.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments and the features and teachings of any embodiment can be interchangeably combined with the features and teachings of any other embodiment. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

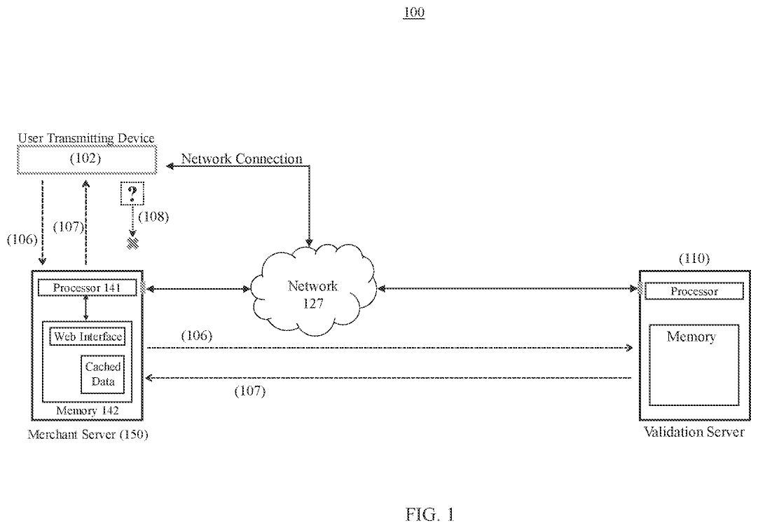

FIG. 1 illustrates a general overview of a validation process associated with online VCN transactions. As discussed above, online processing of electronic transaction strings by credit/debit card networks may require a transaction-initiating entity to provide additional authentication data such as a CVV code associated with a specific credit card number which is generally printed on the back of the physical credit or debit card. The CVV code may correspond to a security code associated with a physical card linked to a user's account. A key attribute of VCN is its merchant-specific implementation involving a merchant-binding technology incorporated into each VCN.

Therefore a VCN transaction instrument corresponds to a set of unique merchant-specific transaction strings, each of which may be associated with a virtual CVV code and a virtual expiration data. The exemplary operational overview (100) particularly highlights a challenge involved in identifying a matching virtual CVV, that maybe required for the validation of a particular merchant-specific VCN, from a plurality of VCNs that may be associated with a user financial account. For example, with reference to the exemplary scenario (100) in FIG. 1 a user may initiate an online VCN transaction, via the user transmitting device (102), with a corresponding merchant point of sale (POS) device and/or server (150) as shown by the transaction initiation request (106). One exemplary scenario may correspond to a re-occurring user-initiated online VCN transaction on a merchant website which may have previously registered user's VCN payment information.

In response, the VCN transaction request (106) may be transmitted to an authentication sever (110). The authentication server may respond back with a transmission (107) corresponding to a request for a unique virtual CVV associated with the merchant-specific VCN in the transaction request (106).

However, as represented by the incomplete data transfer operation (108), a matching virtual CVV, for a merchant-specific VCN may not be readily accessible by the user given the plurality of various merchant-specific VCNs (and corresponding virtual CVV codes) that may be associated with a particular user account. As such, the complexity associated with a possibly large number of unique VCN, each associated with a distinct virtual CVV code, may adversely impact the feasibility and utility provided by this virtual (merchant-specific) transaction instrument (e.g., VCN).

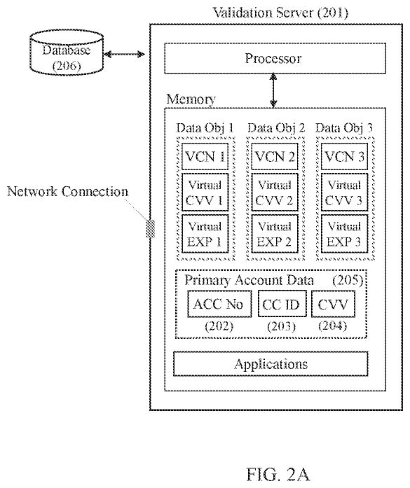

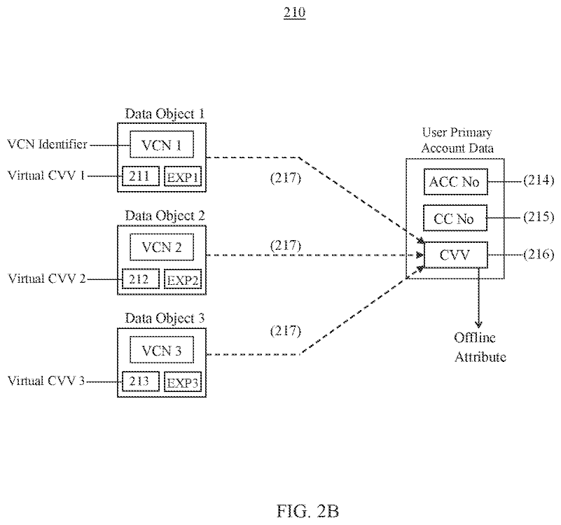

As illustrated in FIG. 2A, an authentication and/or validation server (201) may internally store a set of data structure corresponding, for example, to VCN 1, VCN 2 and VCN 3. In accordance to the exemplary implementation of FIG. 2A, data structure for each distinct VCN is represented as Data Obj 1, Data Obj 2 and Data Obj 3, each comprising a unique VCN identifier (e.g., VCN 1-VCN 3) and a set of corresponding virtual data distinct to each specific VCN. The virtual data connected to each unique VCN (and stored within the corresponding data structure in FIG. 2A) may correspond to a virtual CVV code (e.g., virtual CVV 1-3) and a virtual expiration data (e.g., virtual EXP 1-3). The exemplary validation server (201) may also store data related to a user's primary financial account, such as a primary account number (202), a physical credit or debit card number (203) and a corresponding CVV code (204) associated with the credit/debit card number (203). A user's primary account information may further comprise information such as an expiration data associated with one or more debit and/or credit card numbers (not shown in FIG. 2A). The user's primary account data may be stored on the validation server (201), for example, in a contiguous data structure (205), and/or distributed within the internal and/or external memory of the authentication server (201). The data corresponding to various merchant-specific VCNs and/or user primary account data may also be stored in an external data store (e.g., data base 206) communicatively coupled to the validation server (201).

FIG. 2B illustrates an exemplary scheme (210) involving mapping of VCN data associated with identification and validation of a VCN transaction, to an offline attribute. As described in accordance to the exemplary implementation in FIG. 2A, VCN data may be stored in specific VCN data objects (e.g., Data Object 1-3) comprising a VCN identifier and a set of corresponding virtual attribute values such as a virtual CVV and expiration date. For example, with reference to FIG. 2B, Data Object 1 may represent an identifier for a data structure storing a first VCN (e.g., VCN 1) as well as a first virtual CVV (e.g., 211) and a first virtual expiration date (e.g., EXP1). Similarly Data Object 2 may represent an identifier for a data structure storing a second VCN (e.g., VCN 2) as well as a (second) distinct virtual CVV (e.g. , 212) and a virtual expiration date (e.g., EXP2). FIG. 2B, further reference a third data object (Data Object 3) representing an identifier for a data structure storing a third VCN (e.g., VCN 3) as well as a specific (third) virtual CVV (e.g., 213) and a virtual expiration date (e.g., EXP3). As described above, user primary account and debit/credit card data may be stored on the same storage system as the VCN data and/or a device communicatively coupled thereto. Accordingly, a data object representing VCN data may be mapped to an offline data attribute tied to a user's primary account element.

With reference to the illustrated example in FIG. 2B, the user's primary account element onto which various VCN data sets (e.g., data objects 1-3) are mapped, may corresponds to the CVV (216) tied to a physical debit/credit card (215), which may be associated with the user's primary account number (214). This is illustrated, for example, by the mapping indication (217) in the exemplary illustration of FIG. 2B. In accordance to some embodiments, the system/process may be further configured to include the referenced/mapped data value (e.g., an offline attribute value) as an alternative and/or a secondary validation parameter for processing and validating an online VCN transaction.

As such, in accordance to some embodiments of the present disclosure, a VCN validation process may be modified to include a secondary validation operation for matching the incoming CVV data, corresponding to a VCN transaction, with an offline attribute value, such as the CVV code printed on a physical payment card associated with the user's primary account. Thus enabling a user-provided security code, corresponding to the physical CVV code, to be provided in conjunction with an incoming VCN transaction to the VCN validation process. As previously described, the corresponding user primary account information may be stored in part or in whole on the same storage medium as the VCN (validation) data and/or separately, for example, on a data storage communicatively coupled to the storage medium storing the VCN (validation) data.

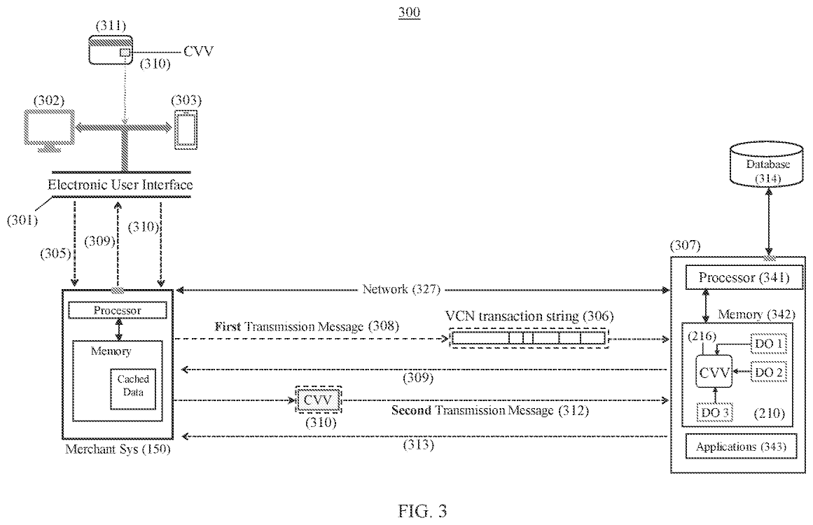

An exemplary operational overview of system (300), featuring a flexible front-end (e.g., user experience) functionality for improving the useability of VCNs as secure transaction instruments, is illustrated in FIG. 3. The enhanced operational flexibility may be facilitated by the sequence of network communications messages and a modified back-end VCN validation process, as illustrated with reference to system 300. Furthermore, with respect to the enhanced feasibility of VCNs in conducting online electronic transaction, the exemplary system (300) enables online VCN transactions to be validated based on a secondary parameter corresponding to a CVV code associated with a user's physical bank card.

Referring back to FIG. 3, a front-end user experience and/or actions, implemented via the electronic user interface (301) may comprise initiation of an online transaction request (305) using a merchant-specific VCN (306) that may be previously stored and/or registered with the merchant system (150). The online transaction request (305) with the merchant-specific VCN (306) may be initiated via a user computing device (302) and/or a user mobile device (303) accessing a merchant website (e.g., payment check out screen). The VCN transaction request (305), including the merchant-specific VCN (306) may then be transmitted, by the receiving merchant system (150) to a transaction validation server (307), for example, via the (first) transmission message (308). Upon receiving the first transmission message (308) a request for a virtual CVV code corresponding to the merchant-specific VCN (306), may be sent back to the merchant system (150). This is exemplified by the virtual CVV request transmission (309). In some embodiments, a virtual CVV request may be generated by the merchant system (150), prior to the transmission of the merchant-specific VCN string (306) to the validation server (307).

The virtual CVV request message (309), received by the merchant server (150), may then be communicated to the user, via the user interface (301). In response to the virtual CVV request message (309), a user may input a physical CVV (310) associated with a physical debit/credit card (311), as illustrated in FIG. 3. The physical CVV (310) may then be transmitted to the validation server (307) via a (second) transmission message (312).

An exemplary mapping and/or referencing relationship configured between a plurality of distinct merchant-specific VCNs and an offline account element/attribute, such as the physical CVV code, is illustrated with reference to the mapping (210) in the validation server (307). With reference to FIG. 3, each VCN data object (e.g., DO 1, 2 and 3) may correspond to a distinct VCN data object storing the relevant virtual attribute values, as well as a reference to an offline attribute such as a physical CVV (216), as previously shown in FIG. 2B. If the user-provided CVV (310), transmitted to the validation server (307) via the transmission message (312), matches either the virtual CVV (e.g., as stored in the corresponding VCN data object) or the physical CVV (216) referenced by the corresponding VCN data object, the transaction request (305) associated with the VCN (306) is validated.

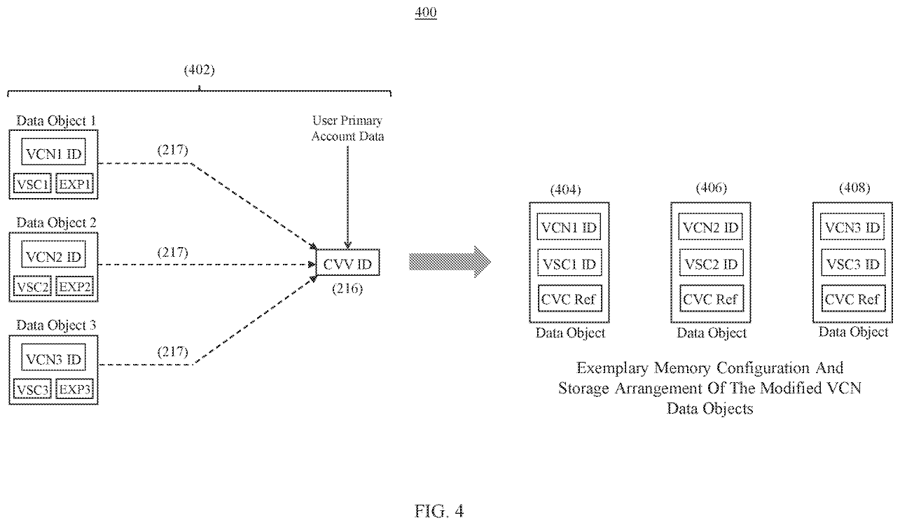

As such, based on the mapping (210), a CVV identifier provided via the (second) transmission message (312), is registered as a bonified CVV parameter by the validation server (307), hence a validation response (313) for authorizing the VCN transaction request (305) may be sent back to the merchant server (150). A further advantage of the illustrated embodiments is that the VCN transaction string (306) and the CVV code (310) are communicated via different transmission sessions (e.g., 308 and 312 respectively), which provides a distinct security benefit when transporting information across a public network such as network (327). The exemplary VCN data structure referencing an offline attribute (e.g., a physical CVV) are further illustrated in FIG. 4

As described above, the system 300 may include a client device (e.g., user mobile device 303 and/or user computing device 302) that provides an electronic user interface (301) for conducting an online interaction with a remote/local transaction system. The transaction validation server (307) may be communicatively coupled to a database (314) and a remote merchant server (150) that may be configured to communicate with the transaction validation server (307) via a public and/or a private network connection (327). The network (327) may also facilitate communication between different components illustrated in FIG. 3. Although FIG. 3 illustrates single instances of each components, the system 300 may include any number of components.

The user device for implementing the user interface (301) may be a network-enabled computer. Exemplary network-enabled computer devices include, without limitation, a server, a network appliance, a personal computer, a workstation, a phone, a handheld personal computer, a personal digital assistant, a thin client, a fat client, an Internet browser, a mobile device, a smart card (e.g., a contactless card or a contact-based card), a kiosk, or any other network-enabled computing and/or communication device. The user device may include a processor, a memory, and one or more applications. The processor may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The validation server (307) may be a network-enabled computer device. The validation server (307) may include a processor (341), a memory (342), and applications (343). The processor (341) may be a processor, a microprocessor, or other processor, and the validation server (307) may include one or more of these processors. The processor (341) may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The database 314 may be one or more databases configured to store data, including without limitation, one or more user identifying and/or financial accounts information, one or more merchant-specific transaction histories. The database (314) may comprise a relational database, a non-relational database, or other database implementations, and any combination thereof, including a plurality of relational databases and non-relational databases. In some examples, the database (314) may comprise a desktop database, a mobile database, or an in-memory database. Further, the database (314) may be hosted internally by the validation server (307) or may be hosted externally and communicatively coupled with the validation server (307). The database (314) may store processed user information, mapping data, etc.

The system 300 may include one or more networks (327). In some examples, the network (327) may be one or more of a wireless network, a wired network or any combination of wireless network and wired network, and may be configured to connect the user (transmitting) device (e.g., 302 and/or 303), the validation server (307) and a merchant system and/or server (150). Database 314 may be connected to validation server 307 via network 327 and/or via a direct connections. The network (327) may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network (327) may include, without limitation, telephone lines, fiber optics, IEEE Ethernet 902.3, a wide area network, a wireless personal area network, a LAN, or a global network such as the Internet. In addition, the network (327) may support an Internet network, a wireless communication network, a cellular network, or the like, or any combination thereof. The network (327) may further include one network, or any number of the exemplary types of networks mentioned above, operating as a stand-alone network or in cooperation with each other. The network (327) may utilize one or more protocols of one or more network elements to which they are communicatively coupled. The network (327) may translate to or from other protocols to one or more protocols of network devices. Although the network (327) is depicted as a single network, it should be appreciated that according to one or more examples, the network (327) may comprise a plurality of interconnected networks, such as, for example, the Internet, a service provider's network, a cable television network, corporate networks, such as credit card association networks, and home networks. The network (327) may further comprise, or be configured to create, one or more front channels, which may be publicly accessible and through which communications may be observable, and one or more secured back channels, which may not be publicly accessible and through which communications may not be observable

FIG. 4 illustrates an exemplary modification (400) of VCN data object to reflect the aforementioned mapping function (e.g., mapping 217) as illustrated, for example by the exemplary representations (210) and (300) in FIGS. 2B and 3, respectively. Referring back to FIG. 4, diagram (402) illustrates a mapping of data parameters, records and/or processes associated with VCN identification and validation (as for example, represented by exemplary data objects 1-3) to a common offline attribute associated, for example, with a user's primary account data, such as the CVV ID (216) that may be printed on a back of a user physical payment card. One exemplary implementation for the data mapping (402), may involve modifying and/or augmenting data objects 1, 2 and 3 (corresponding to three distinct VCNs associated correspondingly with three unique virtual CVV codes and expiry dates) by a data reference to a target offline attribute, such as the physical CVV (216). An example of the modified VCN data objects, corresponding to VCN 1, 2 and 3, is respectively represented in FIG. 4, by the data objects (404), (406), and (408).

In some embodiments, the referencing and/or the mapping operation with respect to the modified VCN data objects may correspond to storing a hash function that may be processed to produce the value of the target offline attribute. In a different implementation, the reference to a target offline attribute may correspond to an algorithm that may be invoked to compute the corresponding attribute value. In some embodiments, the referencing and/or the mapping operation may be represented by a data pointer, in the modified VCN data objects, that points to a memory location storing the target attribute value.

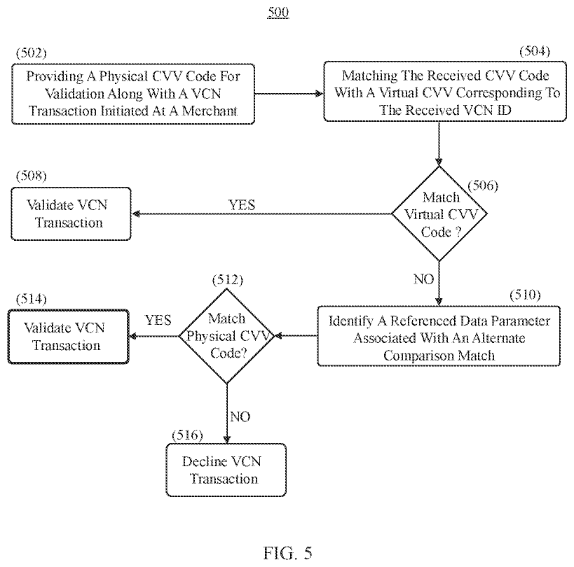

FIG. 5 illustrates an exemplary operational flow diagram (500) pertaining to a modified back-end validation process for facilitating a flexible user experience when conducting an online VCN transaction in accordance to an embodiment of the present disclosure. Referring to the exemplary flow diagram 500, at step 502 a user initiating a VCN transaction at a merchant website may provide a physical CVV code for verification of a VCN transaction. Some embodiments may involve a VCN transaction that is initiated based on previously provided VCN information saved and/or registered by the specific merchant system.

At step 504, a VCN validation process may receive the user provided CVV code (provided in conjunction with a VCN transaction request) through a distinct transmission message following the reception of the VCN transaction string. In accordance to some embodiments, the VCN validation process may first match the received CVV code with a virtual security code (virtual CVV) associated with the received VCN, a shown, for example, at step 506. If a successful match is identified at step 506 (e.g., a user providing a correct virtual CVV associated with the VCN tied to the specific merchant), the VCN transaction may be validated by the VCN validation process. However, if a match with a corresponding virtual CVV is not determined at step 506, the exemplary validation process may identify one or more referenced parameters associated with an alternate comparison match as provided, for example, in a VCN validation data structure (e.g., as shown in FIGS. 3 and 4).

In accordance to some embodiments of the present disclosure, the referenced parameters associated with an alternate comparison match, as identified at step 510, may correspond to a CVV code printed on a user's physical banking card. Accordingly, at step 512, the received CVV is compared to a physical CVV code for the purpose of verification. If no match is determined with respect to the physical CVV, as may have been the case with a virtual CVV matching operation at step 506, the VCN transaction is declined at step 516. However, if a CVV code provided by a user in combination with a VCN transaction does match the physical CVV code, the VCN transaction is validated at step 514.

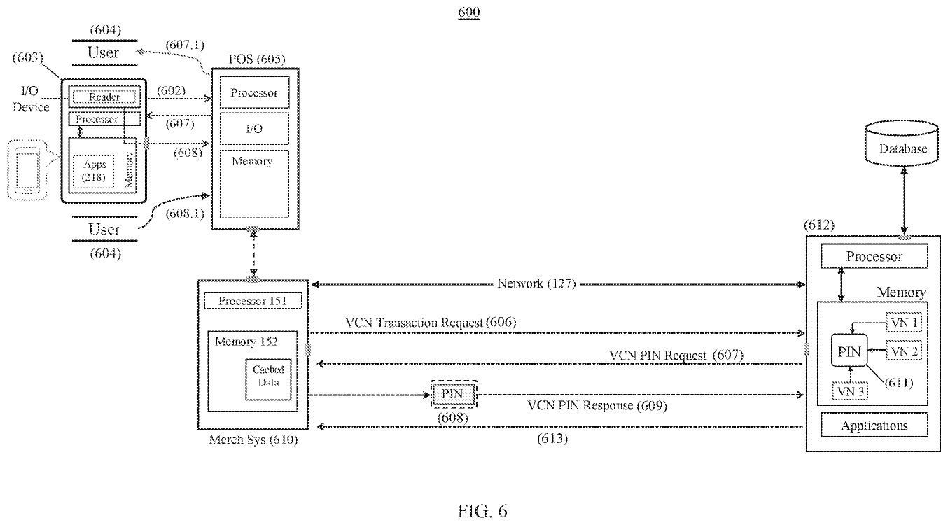

FIG. 6 illustrates an exemplary implementation (600) corresponding to in-person initiated wireless VCN transaction request initiated, for example, via a wireless transmission (602) from a mobile device (603) associated with a user (604). The transmission may be sent to a Point Of Sale (POS) device (605) which may be communicatively coupled with merchant payment gate way/server (610). In the embodiment illustrated in FIG. 6, validation parameters associated with a VCN may further be mapped to, for example, a user PIN number (611). Thus a PIN request message (607) may be transmitted back, by the validation server (612), in response to an incoming VCN transaction request (606). The PIN request may be communicated to the user (604) via, the user mobile device (603). The PIN request (607) may also be communicated to the user (604) by, for example, a teller operating the merchant POS device (605), as illustrated by data path (607.1) in FIG. 6.

A user provided data (608), inputted via mobile device (603), may then be transmitted back to the validation server, via a VCN PIN response (609), and verified by the validation server (612) before a transaction validation response (613) is transmitted back for authorizing the VCN transaction request (602). The user provided data (608) may also be communicated to teller operating the merchant POS device (605) by the user (604), as illustrated by data path (608.1) in FIG. 6, and transmitted therefrom to the validation server (612).

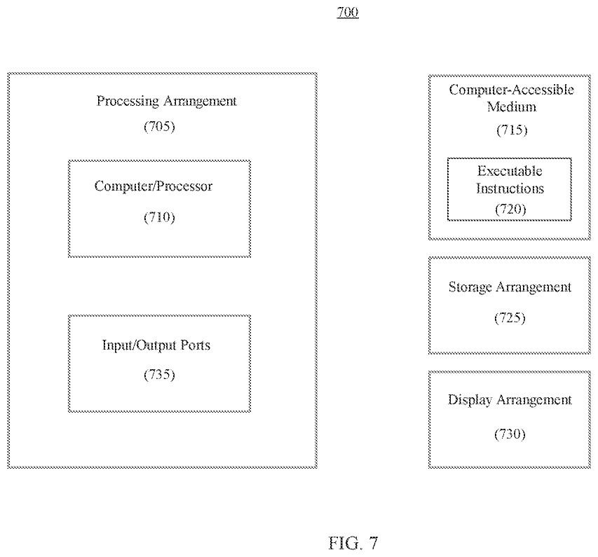

FIG. 7 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 705). Such a processing and/or computing arrangement (705) can be, for example entirely or a part of, or include, but not limited to, a computer and/or processor (710) that can include, for example one or more microprocessors, and use instructions stored on a computer-accessible medium (e.g., RAM, ROM, hard drive, or other storage device).

As shown in FIG. 7, for example a computer-accessible medium (715) (e.g., as described herein may comprise, a storage device such as a hard disk, floppy disk, memory stick, CD-ROM, RAM, ROM, etc., or a collection thereof) can be provided (e.g., in communication with the processing arrangement (705)) The computer-accessible medium (715) can contain one or more executable instructions (720) stored thereon. In addition or alternatively, a storage arrangement (725) can be provided separately from the computer-accessible medium (715), which can provide the instructions to the processing arrangement (705) so as to configure the processing arrangement to execute certain exemplary procedures, processes, and methods, as described herein above, for example.

Further, the exemplary processing arrangement (705) can be provided with or include an input/output ports (735), which can include, for example a wired network, a wireless network, the internet, an intranet, a data collection probe, a sensor, etc. As shown in FIG. 7, the exemplary processing arrangement (705) can be in communication with an exemplary display arrangement (730), which, according to certain exemplary embodiments of the present disclosure, can be a touch-screen configured for inputting information to the processing arrangement in addition to outputting information from the processing arrangement, for example. Further, the exemplary display arrangement (730) and/or a storage arrangement (725) can be used to display and/or store data in a user-accessible format and/or user-readable format.

In some aspects, the techniques described herein relate to a method for improving security of virtual card numbers (VCN), the method including: mapping, via a back-end process, one or more virtual card numbers (VCNs), to a first security code associated with a physical card linked to a user's account, wherein each of the one or more VCNs is associated with a second security code corresponding to a unique VCN-specific virtual security code; receiving, by a back-end validation process, a user-provided security code transmitted in conjunction with a VCN associated with an incoming VCN transaction, wherein the user-provided security code and the VCN associated with the incoming VCN transaction are received via separate network sessions; determining, by the back-end validation process, a match between the user-provided security code and one of the first security code associated with the physical card, and the second security code associated with the VCN in the incoming VCN transaction; and validating, by the back-end validation process, the incoming VCN transaction based on a match between the user-provided security code and one of the first security code and the second security code.

In some aspects, the techniques described herein relate to a method, wherein the first security code corresponds to a card verification value (CVV) printed on the physical card connected to a user's primary account.

In some aspects, the techniques described herein relate to a method, wherein the second security code correspond to a VCN-specific virtual CVV associated with the incoming VCN transaction.

In some aspects, the techniques described herein relate to a method, wherein the incoming VCN transaction can be authenticated based on a successful match between the user-provided security code and one of the first security code and the second security code.

In some aspects, the techniques described herein relate to a method, wherein the first security code and the second security code are stored on a back-end validation server.

In some aspects, the techniques described herein relate to a method, wherein the first security code and the security code are generated by a back-end validation server, using a first algorithm and a second algorithm, respectively.

In some aspects, the techniques described herein relate to a method, wherein the unique VCN-specific security code is stored by a merchant server when the VCN is initially provided to the merchant server in service of a user transaction with the merchant.

In some aspects, the techniques described herein relate to a system for improving useability of VCNs in electronic transactions, the system including a computer hardware arrangement configure to: map, via a back-end process, one or more virtual card numbers (VCNs), to a first security code associated with a physical card linked to a user's account, wherein each of the one or more VCNs is associated with a second security code corresponding to a unique VCN-specific virtual security code; receive, by a back-end validation process, a user-provided security code transmitted in conjunction with an incoming VCN transaction, wherein the user-provided security code and a VCN associated with the incoming VCN transaction are received via separate network sessions; determine, by the back-end validation process, a match between the user-provided security code and one of the first security code associated with the physical card, and the second security code associated with the VCN in the incoming VCN transaction; and validate, by the back-end validation process, the incoming VCN transaction based on a match between the user-provided security code and one of the first security code and the second security code.

In some aspects, the techniques described herein relate to a system, wherein the first security code corresponds to a card verification value (CVV) printed on the physical card connected to a user's account.

In some aspects, the techniques described herein relate to a system, wherein the second security code correspond to a VCN-specific virtual CVV associated with the incoming VCN transaction.

In some aspects, the techniques described herein relate to a system, wherein the incoming VCN transaction can be authenticated based on a successful match between the user-provided security code and one of the first security code and the second security code.

In some aspects, the techniques described herein relate to a system, wherein the first security code and the second security code are stored on a back-end validation server.

In some aspects, the techniques described herein relate to a system, wherein the first security code and the security code are generated by a back-end validation server, using a first algorithm and a second algorithm, respectively.

In some aspects, the techniques described herein relate to a system, wherein a VCN and the unique VCN-specific virtual security code are stored on a merchant server when the VCN is initially provided to the merchant server in service of a user transaction with the merchant.

In some aspects, the techniques described herein relate to a non-transitory computer-accessible medium including instructions for execution by a computer hardware arrangement, wherein upon execution of the instructions the computer hardware arrangement is configured to perform procedure including: mapping, via a back-end process, one or more virtual card numbers (VCNs), to a first security code associated with a physical card linked to a user's account, wherein each of the one or more VCNs is associated with a second security code corresponding to a unique VCN-specific virtual security code; receiving, by a back-end validation process, a user-provided security code transmitted in conjunction with an incoming VCN transaction, wherein the user-provided security code and a VCN associated with the incoming VCN transaction are received via separate network sessions; determining, by the back-end validation process, a match between the user-provided security code and one of the first security code associated with the physical card, and the second security code associated with the VCN in the incoming VCN transaction; and validating, by the back-end validation process, the incoming VCN transaction based on a match between the user-provided security code and one of the first security code and the second security code.

In some aspects, the techniques described herein relate to a non-transitory computer-accessible medium, wherein the first security code corresponds to a card verification value (CVV) printed on the physical card which is connected to a user's primary account.

In some aspects, the techniques described herein relate to a non-transitory computer-accessible medium, wherein the second security code corresponds to a virtual CVV associated with the incoming VCN transaction.

In some aspects, the techniques described herein relate to a non-transitory computer-accessible medium, further including instructions for storing the first security code and the second security code on a back-end validation server.

In some aspects, the techniques described herein relate to a non-transitory computer-accessible medium, further including instructions for generating the first security code and the second security code, using a first algorithm and a second algorithm, respectively.

In some aspects, the techniques described herein relate to a non-transitory computer-accessible medium, further including instructions to provide a merchant-specific VCN and the unique VCN-specific security code to a merchant server to facilitate an initial transaction between a user and the merchant, wherein the VCN and the unique VCN-specific security code are stored on a merchant server.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for improving security of virtual card numbers (VCN), the method comprising:
mapping, via a back-end process, one or more virtual card numbers (VCNs), to a first security code associated with a physical card linked to a user's account, wherein each of the one or more VCNs is associated with a second security code corresponding to a unique VCN-specific virtual security code;
receiving, by a back-end validation process, a user-provided security code transmitted in conjunction with a VCN associated with an incoming VCN transaction, wherein the user-provided security code and the VCN associated with the incoming VCN transaction are received via separate network sessions;
determining, by the back-end validation process, a match between the user-provided security code and one of the first security code associated with the physical card, and the second security code associated with the VCN in the incoming VCN transaction; and
validating, by the back-end validation process, the incoming VCN transaction based on a match between the user-provided security code and one of the first security code and the second security code.

2. The method of claim 1, wherein the first security code corresponds to a card verification value (CVV) printed on the physical card connected to a user's primary account.

3. The method of claim 2, wherein the second security code correspond to a VCN-specific virtual CVV associated with the incoming VCN transaction.

4. The method of claim 1, wherein the incoming VCN transaction can be authenticated based on a successful match between the user-provided security code and one of the first security code and the second security code.

5. The method of claim 1, wherein the first security code and the second security code are stored on a back-end validation server.

6. The method of claim 1, wherein the first security code and the security code are generated by a back-end validation server, using a first algorithm and a second algorithm, respectively.

7. The method of claim 1, wherein the unique VCN-specific security code is stored by a merchant server when the VCN is initially provided to the merchant server in service of a user transaction with the merchant.

8. A system for improving useability of VCNs in electronic transactions, the system comprising a computer hardware arrangement configure to:
map, via a back-end process, one or more virtual card numbers (VCNs), to a first security code associated with a physical card linked to a user's account, wherein each of the one or more VCNs is associated with a second security code corresponding to a unique VCN-specific virtual security code;
receive, by a back-end validation process, a user-provided security code transmitted in conjunction with an incoming VCN transaction, wherein the user-provided security code and a VCN associated with the incoming VCN transaction are received via separate network sessions;
determine, by the back-end validation process, a match between the user-provided security code and one of the first security code associated with the physical card, and the second security code associated with the VCN in the incoming VCN transaction; and
validate, by the back-end validation process, the incoming VCN transaction based on a match between the user-provided security code and one of the first security code and the second security code.

9. The system of claim 8, wherein the first security code corresponds to a card verification value (CVV) printed on the physical card connected to a user's account.

10. The system of claim 9, wherein the second security code correspond to a VCN-specific virtual CVV associated with the incoming VCN transaction.

11. The system of claim 8, wherein the incoming VCN transaction can be authenticated based on a successful match between the user-provided security code and one of the first security code and the second security code.

12. The system of claim 8, wherein the first security code and the second security code are stored on a back-end validation server.

13. The system of claim 8, wherein the first security code and the security code are generated by a back-end validation server, using a first algorithm and a second algorithm, respectively.

14. The system of claim 8, wherein a VCN and the unique VCN-specific virtual security code are stored on a merchant server when the VCN is initially provided to the merchant server in service of a user transaction with the merchant.

15. A non-transitory computer-accessible medium comprising instructions for execution by a computer hardware arrangement, wherein upon execution of the instructions the computer hardware arrangement is configured to perform procedure comprising:
mapping, via a back-end process, one or more virtual card numbers (VCNs), to a first security code associated with a physical card linked to a user's account, wherein each of the one or more VCNs is associated with a second security code corresponding to a unique VCN-specific virtual security code;
receiving, by a back-end validation process, a user-provided security code transmitted in conjunction with an incoming VCN transaction, wherein the user-provided security code and a VCN associated with the incoming VCN transaction are received via separate network sessions;
determining, by the back-end validation process, a match between the user-provided security code and one of the first security code associated with the physical card, and the second security code associated with the VCN in the incoming VCN transaction; and
validating, by the back-end validation process, the incoming VCN transaction based on a match between the user-provided security code and one of the first security code and the second security code.

16. The non-transitory computer-accessible medium of claim 15, wherein the first security code corresponds to a card verification value (CVV) printed on the physical card which is connected to a user's primary account.

17. The non-transitory computer-accessible medium of claim 15, wherein the second security code corresponds to a virtual CVV associated with the incoming VCN transaction.

18. The non-transitory computer-accessible medium of claim 15, further comprising instructions for storing the first security code and the second security code on a back-end validation server.

19. The non-transitory computer-accessible medium of claim 15, further comprising instructions for generating the first security code and the second security code, using a first algorithm and a second algorithm, respectively.

20. The non-transitory computer-accessible medium of claim 15, further comprising instructions to provide a merchant-specific VCN and the unique VCN-specific security code to a merchant server to facilitate an initial transaction between a user and the merchant, wherein the VCN and the unique VCN-specific security code are stored on a merchant server.
